(19) United States
(12) Patent Application Publication
(10) Pub. No.: US 2018/0357034 A1
(43) Pub. Date: Dec. 13, 2018

(54) METHOD AND SYSTEM FOR PLAYING CONTENT USING SMART SIGNAGE DEVICE

(71) Applicant: ELECTRONICS AND TELECOMMUNICATIONS RESEARCH INSTITUTE, Daejeon (KR)

(72) Inventor: Sung Hee LEE, Daejeon (KR)

(21) Appl. No.: 16/004,269

(22) Filed: Jun. 8, 2018

(30) Foreign Application Priority Data
Jun. 8, 2017 (KR) 10-2017-0071797

(51) Int. Cl. G06F 3/14; G09G 5/14

(52) U.S. Cl. CPC G06F 3/1446; G09G 2360/04; G09G 5/14; G06F 3/1454

(57) ABSTRACT

Disclosed is a method and system for playing content using a smart signage device. An embodiment of a content playing method using a smart signage device according to the present disclosure may include: checking coupling or separation of a smart signage device; determining a screen group in association with the coupling or separation of the smart signage device; generating content suitable for the screen group; determining mash-up content assigned to at least one smart signage device included in the screen group; and plying the mash-up content assigned to the at least one smart signage device.

### CROSS REFERENCE TO RELATED APPLICATION

The present application claims priority to Korean Patent Application No. 10-2017-0071797, filed Jun. 8, 2017, the entire contents of which is incorporated herein for all purposes by this reference.

### BACKGROUND OF THE INVENTION

### Field of the Invention

The present disclosure relates generally to a multi-vision system. More particularly, the present invent disclosure relates to a method and system for controlling content played on a multi-vision system.

### Description of the Related Art

It is not easy to implement a large-size electronic board or large-size digital signage device by using one display panel due to cost, process, or technical limitations. Accordingly, a plurality of display devices is connected to each other so as to be used in a multi-vision form. A plurality of display devices included in one multi-vision system may respectively display different images, or display one large-size image by combining the plurality of display devices.

As described above, when configuring a multi-vision system, a plurality of screens is physically connected by one control device and content distribution is performed such that the content is synchronized. However, there is problem in that it is difficult to expand the multi-vision system in consideration of various environments since the manufacturing cost thereof is high and the installation is complicated.

The foregoing is intended merely to aid in the understanding of the background of the present disclosure, and is not intended to mean that the present disclosure falls within the purview of the related art that is already known to those skilled in the art.

### SUMMARY OF THE INVENTION

An object of the present disclosure is to provide a method and system for freely configuring arrangement of a multi-vision system using a smart signage device in real time.

Another object of the present disclosure is to provide a method and system for easily reconfiguring configuration or arrangement of a smart signage device even though the same has to be reconfigured.

It will be appreciated by persons skilled in the art that the objects that could be achieved with the present disclosure are not limited to what has been described hereinabove and the above and other objects that the present disclosure could achieve will be more clearly understood from the following detailed description.

According to an aspect of the present disclosure, there may be provided a method of playing content by using a smart signage device. The method may include: checking coupling or separation of a smart signage device; determining a screen group in association with the coupling or separation of the smart signage device; generating content suitable for the screen group; determining mash-up content assigned to at least one smart signage device included in the screen group according to the content; and plying the mash-up content assigned to the at least one smart signage device.

According to another aspect of the present disclosure, there may be provided a multi-vision system. The multi-vision system may include: at least one smart signage device detecting coupling or separation with/from a neighbor device; a situation reorganization server checking coupling or separation of the at least one smart signage device, providing information required for assigning mash-up content to the at least one smart signage device; a group management server managing a screen group in association with coupling or separation of the at least one smart signage device; a content management server assigning the mash-up content to the at least one smart signage device included in the screen group based on information provided from the situation reorganization server.

It is to be understood that the foregoing summarized features are exemplary aspects of the following detailed description of the present disclosure without limiting the scope of the present disclosure.

According to the present disclosure, there is provided a method and system being capable of freely configuring arrangement of a multi-vision system using a smart signage device in real time.

In addition, according to the present disclosure, there is be provided a method and system being capable of easily reconfiguring configuration or arrangement of a smart signage device even though the same has to be reconfigured.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing a block diagram of a configuration of an embodiment of a smart signage based multi-vision system according the present disclosure;

FIG. 2 is a view showing a detailed configuration of an embodiment of the smart signage based multi-vision system according to the present disclosure;

FIG. 3 is a view showing an example of a screen group used in the smart signage based multi-vision system according to an embodiment of the present disclosure; and

FIG. 4 is a view showing a signal flow of an operation flow of an embodiment of the smart signage based multi-vision system according to the present disclosure.

### DETAILED DESCRIPTION OF THE INVENTION

Hereinbelow, embodiments of the present disclosure will be described in detail so that those skilled in the art can easily carry out the present disclosure referring to the accompanying drawings. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “connected” to another element, it is understood to include not only a direct connection relationship but also an indirect connection relationship. Also, when an element is referred to as “containing” or “having” another element, it means not only excluding another element but also further including another element.

In the present disclosure, the terms first, second, and so on are used only for the purpose of distinguishing one element from another, and do not limit the order or importance of the elements unless specifically mentioned. Thus, within the scope of this disclosure, the first component in an embodiment may be referred to as a second component in another embodiment, and similarly a second component in an embodiment may be referred to as a first component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in an embodiment are also included within the scope of this disclosure. Also, embodiments that include other components in addition to the components described in the various embodiments are also included in the scope of the present disclosure.

In an embodiment of the present disclosure, a smart signage device includes a processor and a storage medium, and refers to a digital signage device capable of processing a predetermined application program by using the processor and the storage medium.

Hereinafter, exemplary embodiments of the present disclosure will be described in detail with reference to the accompanying drawings.

First, a smart signage device may share timeline information of content playing therein by using a network. In addition, configuring a multi-vision system with relatively low cost may be available by using a method of performing synchronizing between smart signage devices based on timeline information. However, under a multi-vision system environment configured by the above method, in order to change arrangement or configuration of smart signage devices constituting the multi-vision system, an administrator has to manually re-change a group of smart signage devices constituting the multi-vision system, and newly generate content customized to the re-changed environment, and thus operational convenience of the multi-vision becomes degraded.

In an embodiment of the present disclosure, even though at least one smart signage device is freely coupled or separated to configure a multi-vision system with various sizes, a system and method being capable of actively displaying content by re-arranging the content according to a configuration or arrangement of at least one smart signage device is provided. By using an embodiment of a system and method according to the present disclosure, it is possible to improve the scalability and operation convenience of the multi-vision system service, and reduce the construction cost thereof. In addition, the exhibition effect may be improved, and a digital signage service providing user experience may be realized.

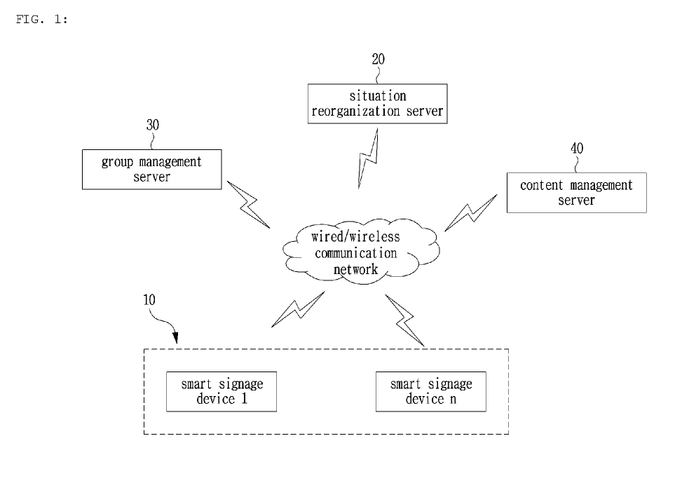

FIG. 1 is a view showing a block diagram of a configuration of an embodiment of a smart signage based multi-vision system according the present disclosure.

An embodiment of a smart signage based multi-vision system 100 according to the present disclosure may include: at least one smart signage device 10, a situation reorganization server 20, a group management server 30, and a content management server 40.

At least one smart signage device 10 may be configured to be coupled and separated with/from devices, and may generate an event corresponding to coupling or separation with/from a neighbor device (smart signage device).

At least one smart signage device 10 may include a sensor detecting coupling or separation, generate information corresponding to coupling or separation, that is, coupling/separation event information, based on a signal detected by the sensor, and provide the information (coupling/separation event information) to the situation reorganization server 20.

The situation reorganization server 20 collects coupling/separation event information of at least one smart signage device 10, requests re-configuration of a screen group in response to the coupling or separation of at least one smart signage device 10, and requests mash-up content based on the re-configured screen group or manages a content state output from the screen group.

The group management server 30 may dynamically re-configure a screen group according to a request of the situation reorganization server 20, control playing of the content, and perform synchronization of the mash-up content.

The content management server 40 may configure content suitable for the screen group according to the request of the situation reorganization server 20, and provide the configured content.

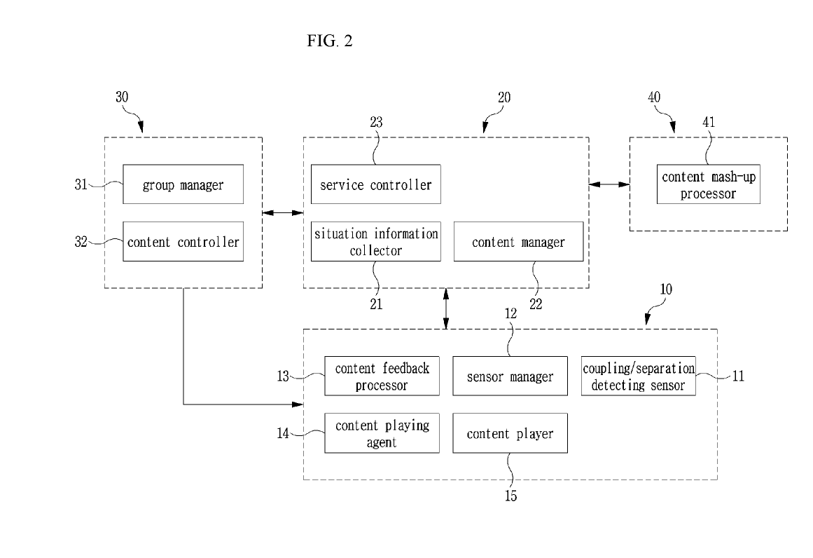

FIG. 2 is a view showing a detailed configuration of an embodiment of the smart signage based multi-vision system according to the present disclosure.

Referring to FIG. 2, the smart signage device 10 may include a coupling/separation detecting sensor 11, a sensor manager 12, a feedback processor 13, a content playing agent 14, and a content player 15.

The coupling/separation detecting sensor 11 may include at least one detection sensor. Particularly, at least one detection sensor may be provided in four areas of the smart signage device 10 which are upper/low/left/right sides. In addition, the coupling/separation detecting sensor 11 may periodically transmit and receive data by using predefined protocol so as to detect whether or not another device (smart signage device) is coupled or separated with/from the four upper/low/left/right areas. For example, the coupling/separation detection sensor 11 may include an IR sensor capable of processing data transmission and reception (TX/RX). The coupling/separation detection sensor 11 may exchange identification information with a neighbor device (smart signage device) by performing data transmission and reception (TX/RX) so as to identify the device (smart signage device) that is coupled or separated with/from itself.

The sensor manager 12 may store positional information (upper/low/left/right) of at least one detection sensor provided in one area of the smart signage device 10 by performing mapping, assign a unique identifier to each detection sensor, and check coupling or separation of another device (smart signage device) based on sensed information.

The feedback processor 13 may generate coupling/separation event information that is event information related to coupling or separation of the smart signage device 10.

The coupling/separation event information may include an event type indicating coupling or separation, a device (smart signage device) identifier, a neighbor device (smart signage device) identifier, and a coupling/separation direction.

In addition, the feedback processor 13 may provide the coupling/separation event information to the situation reorganization server 20 by performing communication with the situation reorganization server 20.

The content playing agent 14 may receive content to be played and playing schedule information from the group management server 30, and provide the same to the content player 15, and the content player 15 may play the content based on the playing schedule information.

The situation reorganization server 20 may include a situation information collector 21, a content manager 22, and a service controller 23.

The situation information collector 21 may receive the coupling/separation event information, check whether or not coupling or separation of another device (smart signage device) has occurred based on information included in the coupling/separation event information, check the device (smart signage device) where the event has occurred, check a neighbor device (smart signage device) where the coupling or separation has occurred, and check a direction where the coupling or separation has occurred.

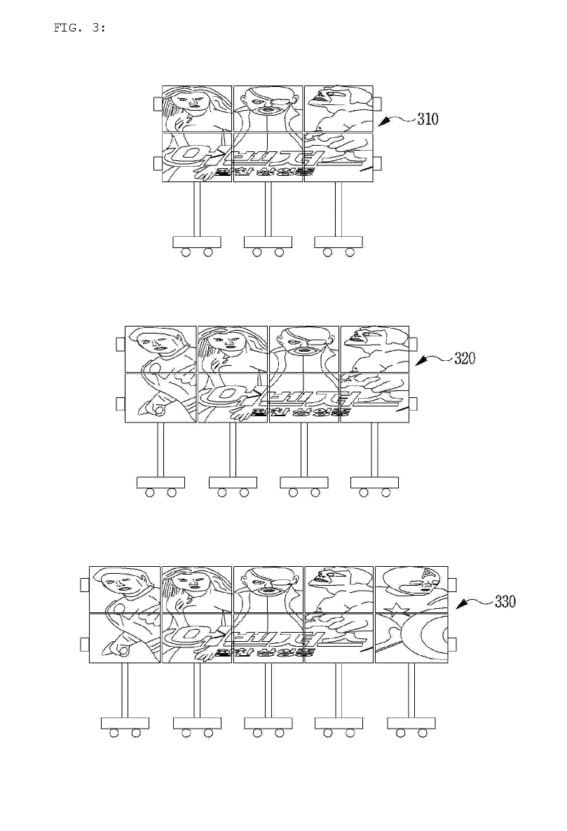

The content manager 22 manages information of content to be played on the reconfigured screen group according to coupling or separation of another device (smart signage device). The content manager 22 may store information in which content corresponding to a display size and a resolution of a smart signage device, a number of smart signage devices is set. In addition, the content manager 22, when coupling or separation of another device (smart signage device) occurs in the screen group (smart signage device), may detect content corresponding to a display size and a resolution of a smart signage device, and a number of smart signage devices included in a corresponding screen group. For example, as shown in FIG. 3, when three smart signage devices are provided in a screen group, first content 310 may be set and stored, when four smart signage devices are provided in a screen group, second content 320 may be set and stored, and when five smart signage devices are provided in a screen group, third content 330 may be set and stored. In addition, when coupling or separation of a device (smart signage) occurs in a screen group so that four smart signage devices are provided in a screen group, the content manager 22 may detect and provide the second content in association with the reconfigured screen group.

The service controller 23 may request reconfiguration of a screen group based on situation information, assign content to the reconfigured screen group, request mash-up content based on arrangement information of the smart signage device provided to the screen group, or process operation of requesting playing the mash-up content.

The group management server 30 may include a group manager 31 and a content controller 32. The group manager 31 may reconfigure a screen group based on coupling/separation information of the smart signage device received from the situation reorganization server 20, and provide information of the reconfigured screen group to the situation reorganization server 20.

The content controller 32 distributes the mash-up content received from the situation reorganization server 20 to at least one smart signage device 10, and controls a playing schedule so that the mash-up content is played on at least one smart signage device 10 by being synchronized.

The content management server 40 may include a content mash-up processor 41, and the content mash-up processor 41 may configure at least one mash-up content to be assigned to the smart signage device included in the screen group based on information of the screen group provided by the situation reorganization server 20, and provide configured mash-up information to the situation reorganization server 20.

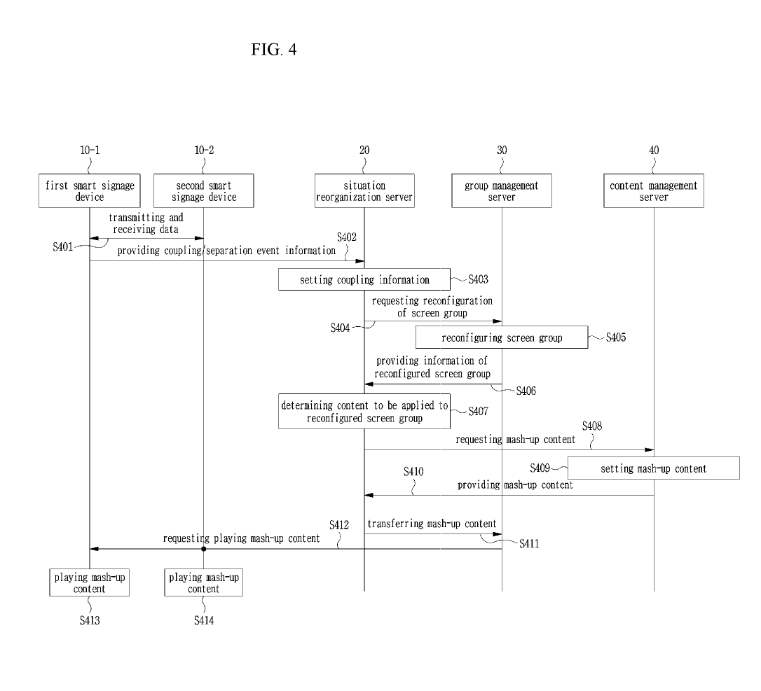

FIG. 4 is a view showing a signal flow of an operation flow of an embodiment of the smart signage based multi-vision system according to the present disclosure.

In FIG. 4, operation of the smart signage based multi-vision system will be described with assumption under a case where a first smart signage device 10-1 constitutes a screen group, a second smart signage device 10-2 is coupled thereto.

In step S401, as the second smart signage device 10-2 moves so that the second smart signage device 10-2 is arranged close to the first smart signage device 10-1, by sensors provided in the first smart signage 10-1 and the second smart signage device 10-2, the smart signage devices are detected from each other. By performing communication between sensors provided in the smart signage devices 10-1 and 10-2 (for, IR communication), the first smart signage device 10-1 may receive an identifier of the second smart signage device 10-2. Then, in step S402, the first smart signage device 10-1 may generate coupling/separation event information indicating that device coupling has occurred, and provide the same to the situation reorganization server 20. Herein, the coupling/separation event information may include information representing an event type, that is, an indicator indicating device coupling, an identifier of the first smart signage device 10-1, directional information indicating a coupling direction, and an identifier of a coupled device (second smart signage devices 10-2).

In step S403, the situation reorganization server 20 may set coupling information of the smart signage devices 10-1 and 10-2 based on coupling/separation event information when the situation reorganization server 20 receives a coupling event from the first smart signage device 10-1.

In step S404, the situation reorganization server 20 transmits the identifier of the coupled device (second smart signage device 10-2), the directional information to the group management server, and request reconfiguration of a screen group.

In step S405, the group management server 30 may check a coupling state of the smart signage based on the received information, and reconfigure a screen group including the first smart signage device 10-1 and the second smart signage device 10-2 in association with the coupling state. In step S406, the group management server 30 transmits information of the reconfigured screen group to the situation reorganization server 20.

In step S407, the situation reorganization server 20 determines content to be applied to the reconfigured screen group based on an administrator policy. Then, in step S408, the situation reorganization server 20 transmits a mash-up request message including screen group information and a content identifier to the content management server 40. In step S409, the content management server 40 sets mash-up content by arranging content to be customized to the configuration of the first smart signage device 10-1 and the second smart signage device 10-2 included in the reconfigured screen group, and in step S410, transmits the set mash-up content to the situation reorganization server 20.

Meanwhile, in step S411, the situation reorganization server 20 retransmits the mash-up content to the group management server 30. Then, in step S412, the group management server 30 assigns the mash-up content to the first smart signage device 10-1 and the second smart signage device 10-2 included in the screen group, and respectively transmits the assigned mash-up content to the first smart signage device 10-1 and the second smart signage device 10-2.

In steps S413 and S414, the first smart signage device 10-1 and the second smart signage device 10-2 respectively play the assigned mash-up content according to a playing schedule.

According to an embodiment of a system and method according to the present disclosure, expansion and modification of the smart signage device become free, and even though the smart signage device is variably modified or configured, content for the same may be actively reconfigured and output. In addition, content may be easily output without modification or manipulation of a user or administrator.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method of playing content by using a smart signage device, the method comprising:
checking coupling or separation of a smart signage device;
determining a screen group in association with the coupling or separation of the smart signage device;
generating content suitable for the screen group;
determining mash-up content assigned to at least one smart signage device included in the screen group according to the content; and
plying the mash-up content assigned to the at least one smart signage device.

2. The method of claim 1, wherein the checking of the coupling or separation of the smart signage device includes: checking coupling/separation event information of the smart signage device.

3. The method of claim 2, wherein the coupling/separation event information of the smart signage device includes an event indicator indicating the coupling or separation, an identifier of the smart signage device, information of a direction where coupling or separation of the smart signage device has occurred.

4. The method of claim 1, the checking of the coupling or separation of the smart signage device includes: receiving, by a situation reorganization server, from the smart signage device, coupling/separation event information including an event indicator indicating the coupling or separation, an identifier of the smart signage device, information of a direction where coupling or separation of the smart signage device has occurred.

5. The method of claim 4, wherein the determining of the screen group includes:
checking, by the situation reorganization server, the coupling/separation event information, and providing the coupling/separation event information to a group management server; and
resetting, by the group management server, the screen group based on the coupling/separation event information, and providing screen group information of the reset screen group to the situation reorganization server.

6. The method of claim 5, wherein the determining of the assigned mash-up content includes:
providing, by the situation reorganization server, the screen group information to a content management server, and requesting mash-up content; and
configuring, by the content management server, the mash-up content based on the screen group information, and providing the mash-up content to the situation reorganization.

7. The method of claim 5, wherein the playing of the mash-up content includes:
providing, by the situation reorganization server, the mash-up content to the group management server;
assigning, by the group management server, the mash-up content to at least one smart signage device included in the screen group; and
respectively providing, by the group management server, the assigned mash-up content to at least one smart signage device.

8. A multi-vision system, the system comprising:
at least one smart signage device detecting coupling or separation with/from a neighbor device;
a situation reorganization server checking coupling or separation of the at least one smart signage device, providing information required for assigning mash-up content to the at least one smart signage device;
a group management server managing a screen group in association with coupling or separation of the at least one smart signage device;
a content management server assigning the mash-up content to the at least one smart signage device included in the screen group based on information provided from the situation reorganization server.

9. The system of claim 8, wherein the at least one smart signage device generates coupling/separation event information of the smart signage device, and provides the coupling/separation event information to the situation reorganization server.

10. The system of claim 9, wherein the coupling/separation event information of the smart signage device includes an event indicator indicating the coupling or separation, an identifier of the smart signage device, information of a direction where coupling or separation of the smart signage device has occurred.

11. The system of claim 8, wherein the situation reorganization server receives coupling/separation event information, and provides the coupling/separation event information to the group management server.

12. The system of claim 11, wherein the group management server resets the screen group based on the coupling/separation event information, and provides screen group information of the reset screen group to the situation reorganization server.

13. The system of claim 12, wherein the situation reorganization server provides the screen group information to the content management server, and requests mash-up content.

14. The system of claim 13, wherein the content management server configures the mash-up content based on the screen group information, and provides the mash-up content to the situation reorganization server.

15. The system of claim 13, wherein the situation reorganization server provides the mash-up content to the group management server, the group management server assigns the mash-up content to at least one smart signage device included in the screen group, and respectively provides the assigned mash-up content to at least one smart signage device.
